(19) United States
(12) Patent Application Publication
(10) Pub. No.: US 2025/0313726 A1
(43) Pub. Date: Oct. 9, 2025

(54) HIGH-PILE PATCHES AND METHOD OF MANUFACTURE

(71) Applicant: NOSO, LLC, Jackson, WY (US)

(72) Inventor: Kelli Marie Jones, Jackson, WY (US)

(21) Appl. No.: 19/173,466

(22) Filed: Apr. 8, 2025

Related U.S. Application Data
(60) Provisional application No. 63/575,918, filed on Apr. 8, 2024.

(51) Int. Cl. C09J 7/21; B23K 26/38; C09J 5/06; C09J 7/35

(52) U.S. Cl. CPC C09J 7/21; B23K 26/38; C09J 5/06; C09J 7/35; C09J 2203/358; C09J 2301/304; C09J 2400/263; C09J 2400/266; C09J 2467/006

(57) ABSTRACT

Patches and methods of forming patches to repair fabric are described. A method for producing adhesive patches includes: (1) providing a fabric layer and an adhesive layer, wherein the adhesive layer comprises a low melt adhesive that activates at room temperature; (2) laminating the adhesive layer to the fabric layer to form a laminated structure, wherein the laminating is selected from the group consisting of bench laminating, roll laminating, and pressing the layers together with friction; (3) allowing the laminated structure to cure, wherein the curing comprises applying warm rollers under pressure to the laminated structure, and wherein the laminated structure is allowed to set for a predetermined time after lamination to let the adhesive set; and (4) laser cutting the cured laminated structure into individual patches using an optical laser head.

### CLAIM FOR PRIORITY

The present application claims the benefit of and priority to U.S. Provisional Application No. 63/575,918 filed on Apr. 8, 2024 and titled “HIGH-PILE PATCHES AND METHOD OF MANUFACTURE,” the entire contents of which are herein incorporated by reference.

### TECHNICAL FIELD

The present invention relates to applique, pressure sensitive, stick on, self-adhesive patches for decorating, repairing, mending, reusing, and/or extending the life of clothing, athletic garments, clothing, gear, blankets, duffels, slippers, and other fabric articles, etc., as well as to the methods for manufacturing and applying the patches.

### BACKGROUND

Patches are well-known for repairing tears or cuts in fabrics. Some patches have been stitched or sewn onto an item of apparel. Traditionally, patches used to repair tears or cuts in fabrics have been made from relatively heavy and rigid woven fabrics, especially when the patch must be waterproof. For example, polyester is a commonly used fabric for apparel and other fabric articles or gear. However, it is estimated that 40% of fashion emissions come from the manufacture of polyester.

Other fabrics are available for constructing fabric articles (e.g., clothing, athletic garments, clothing, gear, blankets, duffels, slippers, etc.). For example, fleece is a commonly used fabric, especially when comfort and warmth are desired qualities for the resulting fabric article. Fleece is an excellent insulator as it efficiently traps body heat, offering superior warmth without the weight and bulk associated with other materials. This quality makes it an ideal option for winter garments.

Additionally, fleece is soft and comfortable. Fleece typically has a napped surface and plush texture to offer a cozy feel against the skin. Despite its excellent heat retention capabilities, fleece is remarkably breathable. It allows air circuation, keeping the skin cool and dry-making it ideal for active wear. Further, fleece is easy to care for, as it can be machine-washed and dried. It's also wrinkle-resistant. These qualities make it ideal for frequent travelers and active individuals. Fleece comes in various weights, textures, and styles, catering to different needs and climates, and is generally more affordable when compared to natural wool.

Fleece is derived from selected fibers and is formed into a molten liquid. The liquid is then forced through tiny holes, known as spinnerets, to create long continuous filaments. These filaments are then collected and spun into a yarn that serves as the building block of the fleece fabric. The spun filaments are the yarn, which is later knitted or woven into a fabric. During the knitting or weaving process, the filaments are interlocked into yarn loops to create a stable and flexible textile structure.

Fleece has a distinct fluffy and soft texture when stroked in one direction. This is because the fabric undergoes brushing or shearing to achieve this smooth and silky texture. In brushing, the fabric is passed through rollers with tiny wire brushes that lift the surface creating the fuzziness. Alternatively, shearing involves trimming the raised fibers to a consistent length, resulting in a smoother finish. While fleece is generally made from polyester, fleece comes in many varieties each having their own properties.

Polyester fleece is the most common type of fleece fabric. It is made entirely from polyester fibers and is known for its durability, lightness, and excellent moisture-wicking and insulation properties. These characteristics make polyester fleece ideal for athletic garments, winter clothing and blankets. Microfleece is a thin and light fabric. Despite its thinness, microfleece offers superb insulation, making it ideal for outdoor enthusiasts who want to move while keeping warm. It is often used to make active wear, such as sweatshirts and sweatpants.

French terry fleece is a blend of traditional fleece and French terry fabric, with a looped terry texture on one side and a smooth surface on the other. It is often used in active wear and casual clothing for its balance of comfort, style and utility. Cotton fleece blends the softness of cotton with the warmth of traditional fleece. It's a comfy and breathable fabric ideal for mild weather conditions. Cotton fleece is often used to make sweatshirts, sweatpants, and lightweight jackets. Additional types of fleece include Sherpa fleece, recycled fleece, and Lycra® spandex fleece.

Articles formed from fleece can become ripped or torn. Some characteristics of fleece can contribute to difficulty in repairing rips or tears. For example, with multiple washes and prolonged wear, fleece may develop pilling (i.e., small balls of thread on the surface). Additionally, fleece tends to fray easily, meaning rips or tears may cause the fleece article to fray and pull apart from the weave endlessly. Fleece is also prone to burning. For example, when sitting next to a campfire, if an ember lays on polyester fleece (most textile manufacturers use polyester to make fleece, as a synthetic material derived from non-renewable fossil fuels like crude oil and natural gas), the fibers ignite immediately.

Self-adhesive patches have been used to repair fabrics. Such patches include an adhesive on one side of the patch, protected by a backing layer. In use, the backing layer is peeled away and the patch can be adhered to the item of apparel using heat or pressure. These patches are useful, but may degrade over time even when they have not yet been applied to gear or a fabric article. Oxygen exposure, for example, may slowly degrade the adhesive. Excessive cold or heat can do the same. High heat and pressure—a common condition inside a backpack carried outdoors during the summer—may cause the backing to adhere firmly to the patch, so that a user cannot peel the backing away when the patch is needed. Conversely in colder weather, unexpected separation of the adhesive and the backing may become a problem: constant jostling may cause the backing layer to separate from the adhesive, which then may become dusty or pick up lint, resulting in poor adherence once the patch is applied to fabric.

Additionally, the adhesive of such patches is typically insufficient to adequately adhere the patch to the napped and high-pile surface of fleece articles. While the fluffy texture of fleece is highly desirable for providing comfortable fabric articles, the adhesive of such patches cannot adequately grasp this texture and maintain the patch in place over a rip or tear. Further, the high-pile of fleece presents a problem for getting an adequate seal about edges of the patch, thereby decreasing the patch's ability to repair the rip or tear as well as stay adhered to the fabric article for long periods of time.

Self-adhering or sticky-back patches are often made in the same manner as paper stickers. Large sheets of fabric are treated with adhesive, a backing is applied to the adhesive, and then the fabric is stamped, punched, or simply cut into suitable sizes. Sometimes, the adhesive patch is supplied to the end user with a separate bottle of additional adhesive, especially when a very tight seal is necessary (such as with patches on inflatable sleeping pads.) These separate bottles may leak, and are easy to lose.

Many types of fabric articles have irregular surfaces, which further reduces the usefulness of self-adhering patches. For example, jackets and blankets may be quilted; tents and backpacks are often crisscrossed with stitched seams. When a self-adhesive patch is placed over such seams or quilting lines, the adhesive may not contact, or adhere well to, the irregular stitch marks of these features.

While self-adhering patches are easy to carry in the event of a rip in the fabric of a piece of outdoor gear, they are not convenient to apply. The ripped article must typically be clean and dry. The patch often must be applied and then adhered with heat. Often heat can be provided by a hair blower or by placing the article in a laundry dryer. Both methods require electricity, which is not readily available in the backcountry, and it can be difficult to fit large articles such as a tent into a consumer-grade laundry dryer. Excessive or uneven heat, applied via either method, can deform or damage very lightweight materials.

Additionally, outdoor gear is often used in difficult and harsh environments. Patches applied to such articles must withstand heat, cold, sunlight exposure, dirt and dust, numerous wash and dry cycles, and often a great deal of stretching, folding, and bending. One of the results of this challenging environment is that portions of the patch-usually the corners first-begin to come loose or separate from the underlying fabric. Once this process begins, dust accumulates between the separated portion of the patch and the fabric, further de-adhering the patch and potentially damaging the fabric further. The patch eventually may peel away from the fabric so much that it can become caught or snagged on other objects, and may be torn away from the fabric, also causing damage, or may leave gummy or sticky adhesive residue behind.

Because of this tendency to degrade from the outer edges, corners, or points, self-adhering patches are often stamped or cut into circular or rounded shapes. Because such shapes lack corners or points, they may not separate as quickly from the fabric to which they are applied. Only a few self-adhesive patches for outdoor use are formed in fanciful or decorative shapes (e.g. the profiles of butterflies, moustaches, or stars), because of the poor adherence characteristics of such shapes. Users may prefer a decorative shape for its aesthetic value, but can use such patches only for gear that sees very little wear or hard use. Staying dry and warm is simply more important in the backcountry.

There is a need for innovative patches and methods of applying and producing patches that are more suitable for active wear apparel and other outdoor gear. It is an advantage if the patch is resistant to degradation as a result of long storage in conditions in heat or cold, even if the patch is jammed into a backpack. It is a further advantage if a patch can be applied in the field, without need for a separate bottle of adhesive or sealant, and without need for a clothes dryer or hairdryer. It is beneficial if the patch can be applied to somewhat dusty fabrics, and/or fabrics with a fuzzy texture, and is suitable for applying to very thin or ultralight fabrics, or over seams or quilted surfaces. In addition, it is beneficial if the patch can be produced in fanciful or decorative shapes, without compromising its adhesive properties.

### SUMMARY

Embodiments of a self-adhesive patch and methods of manufacture are discussed below. The patches and methods include a variety of inventive aspects which can be used together to produce a self-adhering fabric patch that is both decorative and functional with respect to high-pile fabrics, such as fleece. It will be appreciated that various aspects of the invention can be used independently or together and that the invention is set forth in the attached claims rather than the description contained herein.

In various aspects, a method of manufacturing an adhesive patch includes providing a fabric having a first thickness of about 6 mm, the fabric comprising fleece. Additionally, the method includes laminating a sheet of adhesive having a backing to the fabric, the sheet of adhesive having a second thickness ranging from about 0.1 mm to about 0.2 mm, or from about 0.1 mm to about 12 mm, or from about 12 mm to about 26 mm, the second thickness being greater than the first thickness. The method also includes setting the fabric laminated with the sheet of adhesive for a time period of at least one (1) hour and cutting a score on the backing to allow the backing to be cleanly pulled from the sheet of adhesive. Further, the method includes contactlessly cutting a shape through the fabric, the sheet of adhesive and the backing simultaneously after setting and heat-sealing edges of a cut fabric, sheet of adhesive, and backing.

In various aspects, a method of manufacturing an adhesive patch includes providing a fabric having a first thickness ranging from about 1.5 mm to about 15 mm, the fabric comprising fleece. Additionally, the method includes laminating a sheet of adhesive having a backing to the fabric, the sheet of adhesive having a second thickness ranging from about 3 mm to about 26 mm, the second thickness being greater than the first thickness. The method also includes cutting a score on the backing and, after laminating, heat-cutting a shape through the fabric, the sheet of adhesive and the backing.

In various aspects, a method of repairing a fabric article includes placing a patch over a tear of the fabric article. The patch includes a fabric having a first thickness ranging from about 1.5 mm to about 15 mm, the fabric comprising fleece and a sheet of adhesive having a backing, the sheet of adhesive having a second thickness ranging from about 3 mm to about 26 mm and laminated to the fabric. The method also includes heat-sealing the patch to the fabric article, thereby (i) adhering the patch to the fabric article, (ii) sealing any exposed edges of the patch, and (iii) repairing the fabric article. The fabric article may include fleece, where the fleece of the fabric article is the same as the fleece of the fabric of the patch.

### BRIEF DESCRIPTION OF THE DRAWINGS

The following drawings illustrate what are currently considered to be specific representative configurations for carrying out the invention and are not limiting as to embodiments which may be made in accordance with the present invention. The components in the drawings are not necessarily to scale relative to each other. Like reference numerals designate corresponding parts throughout the several views.

The drawings are illustrative and not limiting of the scope of the invention which is defined by the appended claims. The various elements of the invention accomplish various aspects and objects of the invention. Not every element of the invention can be clearly displayed in a single drawing, and as such not every drawing shows each element of the invention.

Various embodiments and features of self-adhesive patches are shown and described in reference to the following numbered drawings:

FIG. 1 is a close-up view of a patch made in accordance with the teachings of the present disclosure and applied to a quilted jacket.

FIG. 2 is a side, cross-sectional view of a patch according to the present disclosure.

FIG. 3 is a view of a patch made in made in accordance with the teachings of the present disclosure and applied to a quilted jacket, with other types of patches applied to the same jacket below.

FIG. 4 is a view of the back side of a patch, including a crack-and-peel backing.

FIG. 5 is a closeup view of a patch made in accordance with the present disclosure, with the backing being slightly peeled away.

FIGS. 6 through 9 are flowcharts of example methods according to the present disclosure.

FIG. 10 is a schematic illustration of one embodiment of a sheet containing a plurality of patches for application to fabric items needing repair.

It will be appreciated that the drawings are illustrative and not limiting of the scope of the invention which is defined by the appended claims. The embodiments shown accomplish various aspects of the invention. It is appreciated that it is not possible to clearly show each element and aspect of an invention in a single figure, and as such, multiple figures are presented to separately illustrate the various details of embodiments of self-adhesive patches and methods of manufacture in greater clarity. Several aspects from different figures may be used in accordance with patches in a single structure. Similarly, not every embodiment need accomplish all advantages of various embodiments of a self-adhesive patch for outdoor gear.

### DETAILED DESCRIPTION

The invention and accompanying drawings will now be discussed in reference to the numerals provided therein so as to enable one skilled in the art to practice the present invention. The skilled artisan will understand, however, that the apparatuses, systems and methods described below can be practiced without employing these specific details, or that they can be used for purposes other than those described herein. Indeed, they can be modified and can be used in conjunction with products and techniques known to those of skill in the art in light of the present disclosure. The drawings and descriptions are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

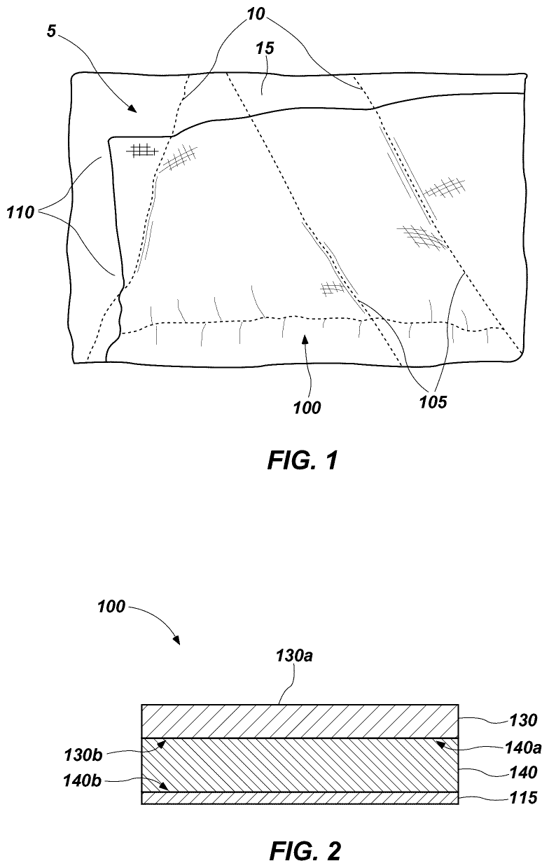

Turning now to FIG. 1, there is shown a fabric article, generally indicated at 5. The fabric article 5 includes quilting lines 10, which are stitched depressions in between baffles 15. The baffles 15 may be, for example, stuffed with down or with other insulating material, or may be arranged purely for decorative purposes. The fabric article 5 may be formed of any type of fleece, such as polyester fleece, microfleece, Sherpa fleece, polar fleece, French terry fleece, cotton fleece, or any combination thereof. The fabric article 5 may have a thickness ranging from about 1.5 mm to about 15 mm, such as 2, 4, 6, 8, 10, 12, 14 mm, or a thickness within a range defined by any two of the foregoing values. The fabric article 5 may also have a napped or otherwise plush texture.

Applied to this fabric article 5 is an adhesive patch made in accordance with the present disclosure, generally indicated at 100. A major challenge with adhesive patches is that they do not bond well with high-pile fabrics, such as fleece, as well as quilting or stitch lines 10.

One means of overcoming this limitation is to use a layer of adhesive which may be thicker than the fabric of the patch. This results in a patch which forms close-fitting divots 105 where it crosses stitch lines 10. Adhesive thickness may vary between application methods. In some embodiments, the adhesive thickness may be roughly two times (2×) the thickness of the fabric article 5. In some embodiments, the adhesive thickness may be roughly three times (3×) the thickness of the fabric article 5. In some embodiments, the adhesive thickness may be roughly four times (4×) or more the thickness of the fabric article 5. For example, the adhesive thickness may range from about 3 mm to about 26 mm, such as 4, 6, 8, 10, 12, 14, 16, 18, 20, 22, 24 mm, or a thickness within a range defined by any two of the foregoing values. In other embodiments, a slightly heavier-duty fabric may be used-especially where a metallic-looking patch is desired-however the ratio of fabric to adhesive (e.g., 1:2, 1.5:2, 1:3, 1.5:3, etc.) may stay the same to ensure adherence to and over the stitch lines 10 and/or rough/textured fabric with the same fidelity. Additionally, the adhesive layer may comprise a low melt adhesive that activates at room temperature or slightly above room temperature. In other configurations, the adhesive may have a thickness ranging from about 0.1 mm to about 0.2 mm, or from about 0.1 mm to about 12 mm, or from about 12 mm to about 26 mm.

As seen in FIG. 2, the patch fabric 130 has an external side 130a. The external side 130a is the side that will face the exterior of the fabric article, fleece fabric, article of clothing, sleeping bag, etc., and will be seen by the user, when the patch 100 is in place. The internal side of the fabric 130b is the side which is laminated to the adhesive layer 140. The adhesive layer 140 is laminated to the fabric 130 on a first side 140a, and is covered by a backing 115 on a second side 140b.

Thick layers of adhesive 140 may require additional curing time, in order to bond fully with the fabric layers 130. One means of producing a patch 100 is to select a roll of fabric 130, and spread it out across a roll of adhesive 140 with a backing layer 115. The fabric 130 and adhesive 140 are then laminated together using pressure, and allowed to cure, before cutting individual patches 100. The back 130b of the fabric 130 may be bench laminated to the roll of adhesive 140 having a paper backing 115. Additionally, and/or alternatively, the adhesive 140 may be laminated to the back 130b of the fabric 130 web-to-web. Any suitable lamination method may be used, such as bench laminating, roll laminating, and pressing the layers together with friction.

In some embodiments, the adhesive 140 and fabric 130 are allowed to set for an hour after lamination, to let the adhesive cure and set. The best bond integrity between fabric 130 and adhesive 140 may occur several days after lamination. Setting or curing allows the adhesive 140 to adequately interact and adhere to the napped, thick internal side 130b of the fabric 130. Additional steps may also be taken to cure, such as applying warm rollers under pressure to the laminated structure (the laminated structure comprised of the adhesive layer 140 and the fabric layer 130).

One advantage of using a comparatively thick layer of adhesive 140 is that the adhesive layer 140 may form a seep or edge-seal 110 (see FIG. 1) approximately from about 0.5 mm to about 2.5 mm, or about 1.5 mm ( 1/16″) wide around the rim of the patch 100, when the patch 100 is applied to fabric articles 5 in the presence of sufficient heat.

In some embodiments, once lamination is complete, the patches 100 are then cut contactlessly, such as with a laser or heat punch, and the back of each patch 100 is scored or kissed along the backing layer 115, as described in more detail below. Contactless cutting does not warp or distort the fabric as only lasers and/or heat are coming into contact with the fabric 130 rather than blades. Contactless cutting also provides the ability to cut and process the fabric 130, the adhesive 140, and the backing 115 in all directions, independent of fabric structure. Additionally, the laser or heat cutting can produce very fine, filigree details in the resulting patch 100. In some embodiments, the cured laminated structure is cut into individual patches using an optical laser head.

Laser or heat cutting also allows for embossing or engraving the fabric 130. With the high-pile of fleece, the textile can be finished with letters, shapes, high quality designs, logos, and more. The high-pile of the fleece fabric naturally contains an inconsistent surface (e.g., having highs and lows), which outline the contoured shape of the letters, shapes, logo etc. The engraving leaves a shadow or indent in the fleece fabric. The laser can be used to create high-quality designs, letters, shapes, or logos on the surface of the fabric, particularly suitable for fleece fabric, thereby creating a contoured effect with a shadow or indent in the fabric.

Laser cutting may also utilize camera recognition of printed fabrics. In some embodiments, laser cutting further comprises camera recognition of printed fabrics, thereby enabling accurate cutting of patches with specific logos, artwork, QR codes, UPC codes, letters, or images.

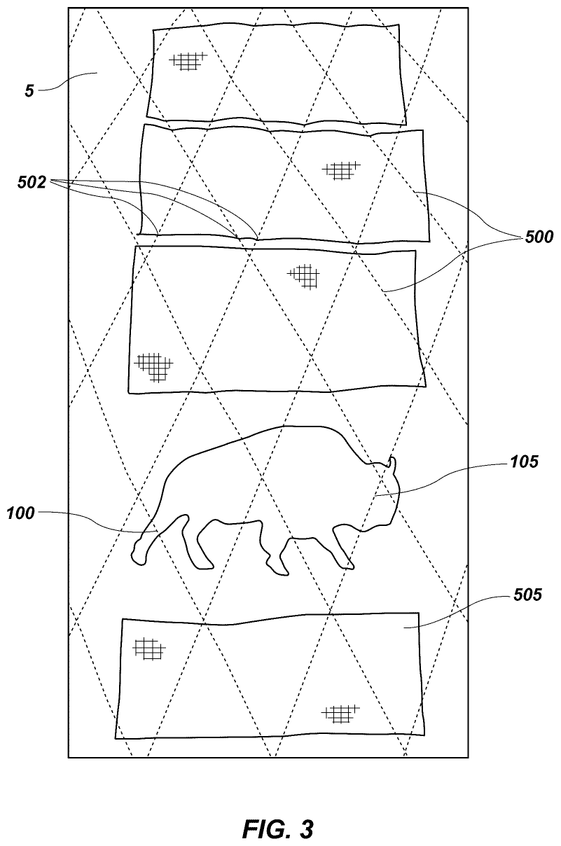

FIG. 3 shows a view of a patch 100 made in made in accordance with the teachings of the present disclosure and applied to a quilted fabric article 5, with other types of patches applied to the same fabric article 5. The patch 100 forms patch divots 105 where the patch 100 adheres closely to the underlying stitch lines. Additional prior art patches 500, adhered to the same material, do not follow the underlying stitch and seam lines with high fidelity, and frequently form gaps 502 along the edges, where a seam line passes beneath the edge of the prior art patch 500. Prior patches 500 typically have a thick fabric layer and a thin layer of pressure-sensitive adhesive disposed on one side of the fabric; such fabrics are typically at least about 0.03556 centimeters (0.014 inches) thick and the adhesive layers are typically about 0.00762 centimeters (0.003 inches) thick.

In a washing adherence test, a patch 100 made in accordance with the present disclosure was washed and dried in a household laundry washer and dryer for 50 cycles, alongside other patches 500 and a strip of duct tape 505. The duct tape 505 fell off in the first wash/dry cycle. While the patch 100 made in accordance with the present disclosure remained adhered to the underlying material during the entire test, every other brand of patch 500 began to peel up at the corners or points by the 7th wash/dry cycle. By the 12th to 16th cycle, every other patch 500 had begun to crack, and the peeling corners worsened until the patches could become snagged on other articles of clothing or environmental hazards. The patch 100 made in accordance with the present disclosure remained firmly adhered, without peeling or cracking, for the entire 50-cycle test.

Patches 100 made in accordance with the present disclosure have greatly-increased T-Peel strength from a fleece substrate compared to typical patches 500, and also increased static shear strength.

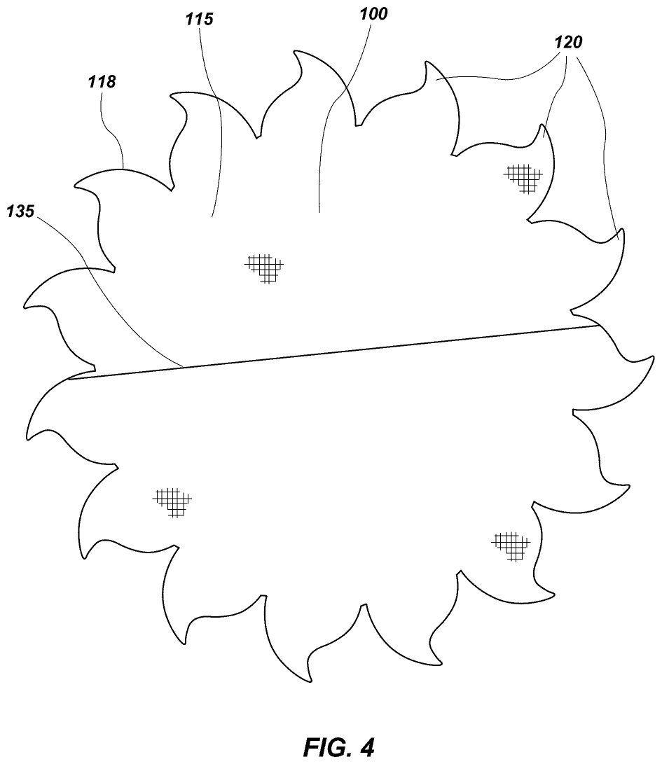

Turning now to FIG. 4, there is shown a back of an adhesive patch 100 made in accordance with the present disclosure. The patch 100 is viewed from the backing 115 side, with the fabric 130 hidden by the cut-to-match backing 115. The backing 115 may be a waxy paper layer or other appropriate material. During manufacture of the adhesive patch 100, after the fabric 130 is allowed to cure with the adhesive 140 and backing 115, both the fabric 130 and the backing 115 may be laser-cut or heat-punched. Additionally, the backing 115 is scored or kissed 135 across a portion of each patch 100. Ideally, the scoring 135 does not cut through the full thickness of the backing 115.

Thus, when a user wishes to apply the patch 100, he or she can fold the patch 100 along the line of the score 135. This ruptures the backing 115, allowing the backing 115 to be peeled cleanly away from the patch 100. However, while in storage (for example, while the patch is still in its packaging), the score line 135 remains unruptured. Thus, very little oxygen or humidity penetrates the backing 115, resulting in adhesive 140 which does not age or degrade during storage.

The scored back 135 also aids users in precisely positioning the patch 100, before it is adhered to a surface or thick fabric article. The backing 115 may be partly peeled away from either side of the score line 135, and the user may adhere the center portion of the patch 100 to the article needing repair first, and then finish peeling away the backing 115 and adhering the remaining portions of the patch 100. This reduces the chance that a user will inadvertently touch the adhesive layer 140, which may leave finger oils or dust and interfere with the bonding. After adhering the patch 100, the user may apply heat to seal the patch 100 to the fabric article, such as by creating sealed edges 110.

According to one aspect, heat of around 26.6 degrees Celsius (around 80 degrees Fahrenheit) is sufficient to heat seal the patch 100 to a fabric article. According to another aspect, a user may apply heat to the patch 100 by placing the article with the patch 100 into a dryer. In this configuration, heat of less than around 65.5 degrees Celsius (150 degrees Fahrenheit) may be used to seal the patch 100 to the fabric article. In other configurations, heat of less than around 51.6 degrees Celsius to around 57.2 degrees Celsius (125 degrees to 135 degrees Fahrenheit) may be used to seal the patch 100 to the fabric article. In other configurations, no heat is required to seal the patch to the fabric article.

An additional location where oxygen or moisture infiltration is a concern on most adhesive patches 100 is the edge 118, particularly when the patch 100 is cut into shapes having points 120 or other fanciful designs. However, as described above, patches 100 made in accordance with the present disclosure may be, for example, laser-cut or heat-punched. The result of this specialized cut (e.g., a “simultaneous cut and seal”) is that the edges 118 of each patch shape have a region in which the backing 115, the adhesive 140, and the fabric 130 are bonded together more tightly than the rest of the patch 100. Thus, air, moisture, and oxygen do not penetrate the patch edges 118 while the patch 100 is in storage.

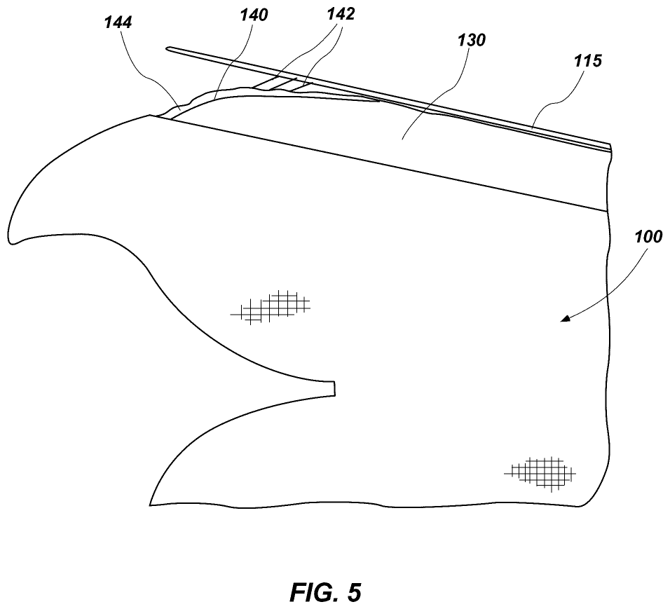

Turning now to FIG. 5, there is shown a closeup view of a backing 115 being slowly peeled away from a patch, indicated generally at 100, made in accordance with the present disclosure. The fabric 130 of the patch 100 can be seen through the thicker layer of adhesive 140. As a result of the method of manufacture herein disclosed, small strings or threads or ropes 142 of adhesive 140 may stretch between the backing 115 and the adhesive layer 140 bonded to the fabric 130 as the backing 115 is carefully peeled away from the fabric 130. In some embodiments, depending on the relative thickness of fabric 130 and adhesive 140, the adhesive 140 may form a rim or cusp 144 all along the edge of the patch 100, as the backing 115 is peeled carefully away.

According to another aspect, the fleece fabric articles used for the patches 100 may be dyed and/or printed. For example, the fabric articles may be dyed in large batches using dye sublimation and direct to garment digital printing techniques. Dye sublimation is a digital printing technology that uses heat transfer to apply an image to the intended substrate. Also referred to as digital sublimation, the process is commonly used for decorating apparel, signs, and banners as well as other items with sublimation-friendly surfaces like polyester.

Dye sublimation printing features the following two-part process: (i) print graphics onto special transfer paper using sublimation printer and inks; and (ii) use a heat press to transfer the ink-on-paper to the substrate. In step 1, unique sublimation dyes are transferred to sheets of “transfer” paper via liquid gel ink. The ink is deposited on these high-release inkjet papers, which are used for the next step of the sublimation printing process. In step 2, the printed transfer sheets are transferred through heat, which converts the solid dye into a gaseous form without going through a liquid form. Heat coupled with pressure causes the dye to penetrate the interior of the substrate, creating a permanent color bond. Once the heat is removed, the dye returns to a solid form and the process is complete. Because colors are embedded in the fabric, rather than printed on the surface, images on fabric won't fade or crack even after multiple washings.

It will be appreciated that the fabric may be dyed via several different methods, including silk screening and dye sublimation. Silk screening is not often used to decorate adhesive patches, as the textile ink used may introduce trace moisture or create coatings on the fabric, which could interfere with the bond between fabric and adhesive. Dye sublimation tends to be suitable for polyester patches only, because nylon may melt at the temperatures employed to transfer the printed image from the paper to the sublimation-ready surface. Surprisingly, dye sublimation is suitable for the fleece fabrics used in constructing the patches 100.

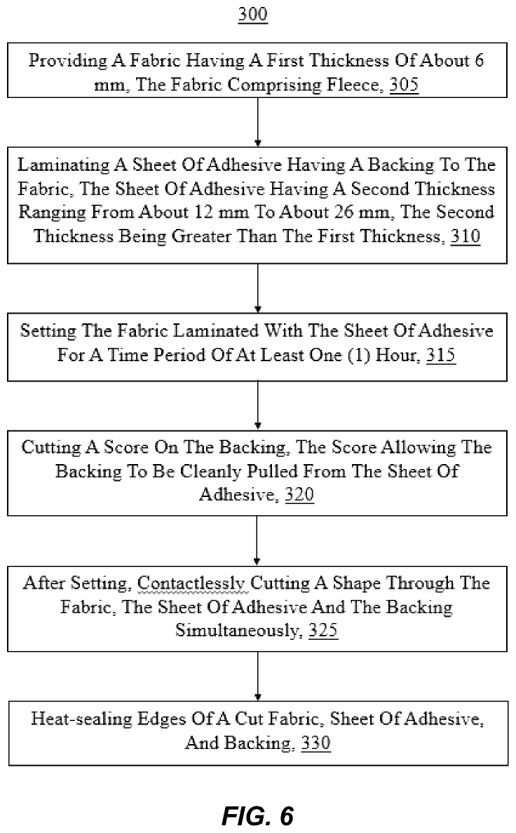

FIGS. 6 through 9 are flowcharts of example methods according to the present disclosure. FIG. 6 illustrates a method 300 of manufacturing an adhesive patch, such as the patch 100. The method 300 includes providing a fabric having a first thickness of about 6 mm, the fabric comprising fleece, at 305. The method 300 also includes laminating a sheet of adhesive having a backing to the fabric, the sheet of adhesive having a second thickness ranging from about 12 mm to about 26 mm, the second thickness being greater than the first thickness, at 310. Further, the method 300 includes setting the fabric laminated with the sheet of adhesive for a time period of at least one (1) hour, at 315, and cutting a score on the backing, the score allowing the backing to be cleanly pulled from the sheet of adhesive, at 320. Still further, the method 300 includes, after setting, contactlessly cutting a shape through the fabric, the sheet of adhesive and the backing simultaneously, at 325. The method 300 also includes heat-sealing edges of a cut fabric, sheet of adhesive, and backing.

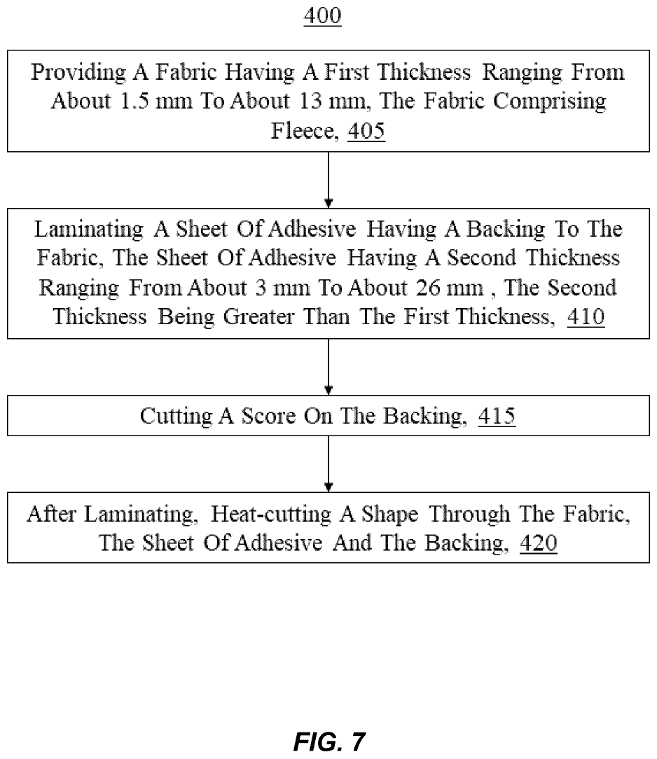

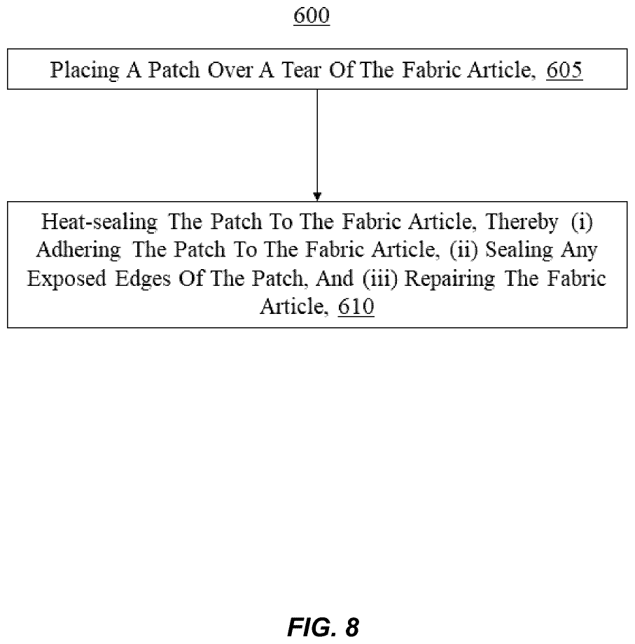

FIG. 7 illustrates a method 400 of manufacturing an adhesive patch, such as the patch 100. The method 400 includes providing a fabric having a first thickness ranging from about 1.5 mm to about 15 mm, the fabric comprising fleece, at 405. The method 400 also includes laminating a sheet of adhesive having a backing to the fabric, the sheet of adhesive having a second thickness ranging from about 3 mm to about 26 mm, the second thickness being greater than the first thickness, at 410. In other configurations, the adhesive may have a thickness ranging from about 0.1 mm to about 0.2 mm, or from about 0.1 mm to about 12 mm, or from about 12 mm to about 26 mm. The method 400 also includes cutting a score on the backing, at 415, and after laminating, heat-cutting a shape through the fabric, the sheet of adhesive and the backing, at 420.

FIG. 8 illustrates a method 600 of repairing a fabric article. The method 600 includes placing a patch over a tear of the fabric article, at 605, the patch comprising: a fabric having a first thickness ranging from about 1.5 mm to about 15 mm, the fabric comprising fleece and a sheet of adhesive having a backing, the sheet of adhesive having a second thickness ranging from about 3 mm to about 26 mm and laminated to the fabric. In other configurations, the adhesive may have a thickness ranging from about 0.1 mm to about 0.2 mm, or from about 0.1 mm to about 12 mm, or from about 12 mm to about 26 mm. The method 600 also includes heat-sealing the patch to the fabric article, thereby (i) adhering the patch to the fabric article, (ii) sealing any exposed edges of the patch, and (iii) repairing the fabric article, at 610. The fabric article comprises fleece, the fleece of the fabric article being the same as the fleece of the fabric of the patch.

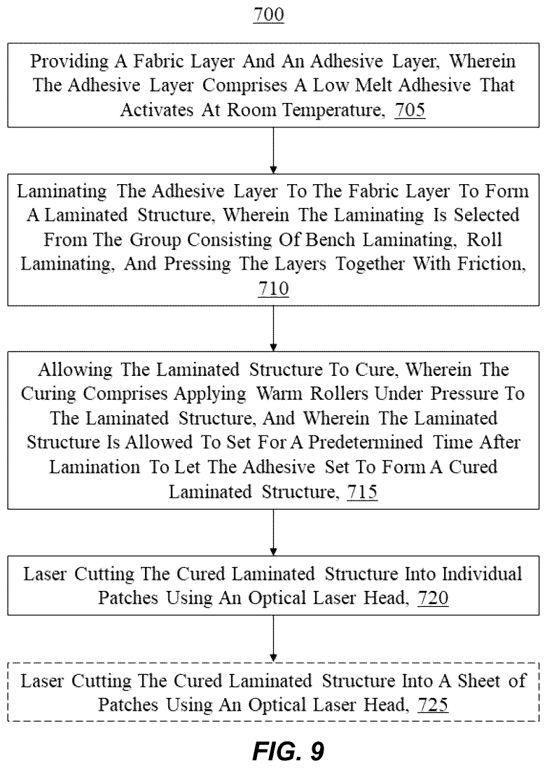

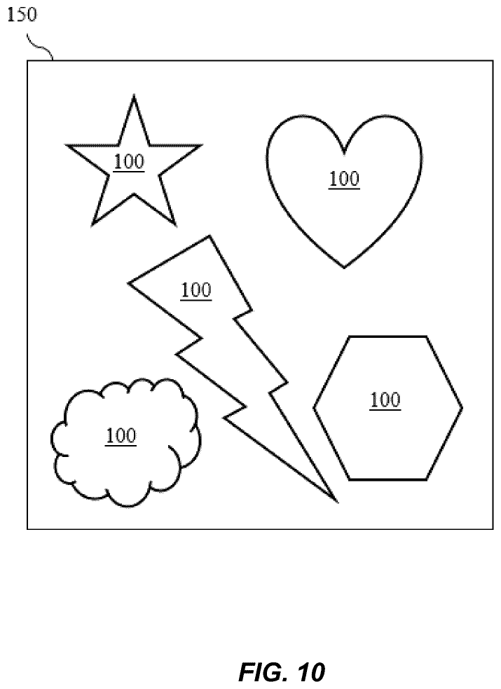

FIG. 9 illustrates a method 700 of manufacturing or forming a patch, such as the patches 100 described and illustrated herein. The method 700 may include providing a fabric layer and an adhesive layer, wherein the adhesive layer comprises a low melt adhesive that activates at room temperature, at 705. The method 700 may also include laminating the adhesive layer to the fabric layer to form a laminated structure, wherein the laminating is selected from the group consisting of bench laminating, roll laminating, and pressing the layers together with friction, at 710. Further, the method 700 may include allowing the laminated structure to cure, wherein the curing comprises applying warm rollers under pressure to the laminated structure, and wherein the laminated structure is allowed to set for a predetermined time after lamination to let the adhesive set to form a cured laminated structure, at 715. Still further, the method may include laser cutting the cured laminated structure into individual patches using an optical laser head, at 720. The individual patches may then be utilized to repair an article of clothing or another fabric item. As before, the adhesive layer may be thicker than the fabric layer and form an edge around the patch, lending increased integrity to the patch.

Additionally, and/or alternatively to cutting the cured laminated structure into individual patches, the method 700 may include laser cutting the cured laminated structure into a sheet of patches using an optical laser head, at 725 (shown in dotted lines to indicate this is optional). For example, FIG. 10 illustrates a sheet 150 including a plurality of patches 100 that may be removed from the sheet 150 to repair an article of clothing or another fabric item. In some embodiments, the patches 100 are cut or trimmed out of the sheet 150, peeled off of a backing layer, and placed on a fabric item. In other embodiments, the patches 100 are scored or perforated and can be peeled from the sheet 150 and directly placed on a fabric item needing repair. For example, the sheet 150 as the cured laminated structure may be laser cut into individual patches using an optical laser head, where the individual patches 150 may then be peeled off the sheet 150 for use.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

Thus, there is disclosed a self-adhesive patch and methods of manufacture. It will be appreciated that numerous changes may be made to the above-disclosed embodiments of patches and associated methods without departing from the scope of the claims. The appended claims are intended to cover such modifications.

### EMBODIMENTS

Embodiment 1: A method for producing adhesive patches comprising: providing a fabric layer and an adhesive layer, wherein the adhesive layer comprises a low melt adhesive that activates at room temperature; laminating the adhesive layer to the fabric layer to form a laminated structure, wherein the laminating is selected from the group consisting of bench laminating, roll laminating, and pressing the layers together with friction; allowing the laminated structure to cure, wherein the curing comprises applying warm rollers under pressure to the laminated structure, and wherein the laminated structure is allowed to set for a predetermined time after lamination to let the adhesive set; and laser cutting the cured laminated structure into individual patches using an optical laser head.

Embodiment 2: The method of embodiment 1, wherein the predetermined time for allowing the laminated structure to set after lamination is about one hour.

Embodiment 3: The method of embodiment 1, wherein the adhesive layer further comprises a paper backing layer.

Embodiment 4: The method of embodiment 1, wherein the best bond integrity between the fabric layer and the adhesive layer occurs several days after lamination.

Embodiment 5: The method of embodiment 1, wherein the adhesive layer requires additional curing time to fully bond with the fabric layer.

Embodiment 6: The method of embodiment 1, wherein the laminating comprises applying pressure to the layers using friction.

Embodiment 7: The method of embodiment 1, wherein the laminated structure is cut into individual patches after the curing.

Embodiment 8: The method of embodiment 1, wherein the laser cutting further comprises sealing the edges of the individual patches, thereby preventing fraying and providing a finished appearance, particularly when cutting synthetic textiles such as fleece.

Embodiment 9: The method of embodiment 1, wherein the laser cutting is performed in a contactless manner, thereby preventing distortion of the fabric during the cutting process.

Embodiment 10: The method of embodiment 1, wherein the laser cutting is capable of precisely cutting very filigree details in the fabric, thereby allowing for intricate designs in the individual patches.

Embodiment 11: The method of embodiment 1, wherein the laser cutting enables cutting and processing in all directions, independent of the fabric structure, thereby providing flexibility in the design and shape of the individual patches.

Embodiment 12: The method of embodiment 1, wherein the laser cutting further comprises camera recognition of printed fabrics, thereby enabling accurate cutting of patches with specific logos, artwork, QR codes, UPC codes, letters, or images.

Embodiment 13: The method of embodiment 1, further comprising a laser embossing or engraving, wherein the laser is used to create high-quality designs, letters, shapes, or logos on the surface of the fabric, particularly suitable for fleece fabric, thereby creating a contoured effect with a shadow or indent in the fabric.

Reference in the specification to “one configuration” “one embodiment,” “a configuration” or “an embodiment” means that a particular feature, structure, or characteristic described in connection with the configuration is included in at least one configuration, but is not a requirement that such feature, structure or characteristic be present in any particular configuration unless expressly set forth in the claims as being present. The appearances of the phrase “in one configuration” in various places may not necessarily limit the inclusion of a particular element of the invention to a single configuration, rather the element may be included in other or all configurations discussed herein.

Furthermore, the described features, structures, or characteristics of configurations of the invention may be combined in any suitable manner in one or more configurations. In the following description, numerous specific details are provided, such as examples of products or manufacturing techniques that may be used, to provide a thorough understanding of configurations of the invention. One skilled in the relevant art will recognize, however, that configurations of the invention may be practiced without one or more of the specific details, or with other methods, components, materials, and so forth. In other instances, well-known structures, materials, or operations are not shown or described in detail to avoid obscuring aspects of the invention.

Before the present invention is disclosed and described in detail, it should be understood that the present disclosure is not limited to any particular structures, process steps, or materials discussed or disclosed herein, but is intended to include equivalents thereof as would be recognized by those of ordinarily skill in the relevant art. More specifically, the invention is defined by the terms set forth in the claims. It should also be understood that terminology contained herein is used for the purpose of describing particular aspects of the invention only and is not intended to limit the invention to the aspects or configurations shown unless expressly indicated as such. Likewise, the discussion of any particular aspect of the invention is not to be understood as a requirement that such aspect is required to be present apart from an express inclusion of the aspect in the claims.

It should also be noted that, as used in this specification and the appended claims, singular forms such as “a,” “an,” and “the” may include the plural unless the context clearly dictates otherwise. Thus, for example, reference to “a shape” may include one or more of such shapes, and reference to “the layer” may include reference to one or more of such layers.

As used herein, the term “substantially” refers to the complete or nearly complete extent or degree of an action, characteristic, property, state, structure, item, or result to function as indicated. For example, an object, that is “substantially” adhered would mean that the object is either completely adhered or nearly completely adhered. The exact allowable degree of deviation from absolute completeness may in some cases depend on the specific context. The use of “substantially” is equally applicable when used in a negative connotation to refer to the complete or near complete lack of an action, characteristic, property, state, structure, item, or result.

Likewise, the term generally is used to identify a situation in which some is close enough that it would commonly be considered to be a described feature, position, etc., even though it is not exactly so. For example, a structure may be said to be generally cut to right angles even though the angle is not exactly 90 degrees. In other words, an angle of 80 degrees may be said to be generally at right angles. The exact range will be determined by the ordinary usage of a person of ordinary skill in the art.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

What is claimed is:

1. A method of manufacturing an adhesive patch, the method comprising:
providing a fabric having a first thickness of about 6 mm, the fabric comprising fleece;
laminating a sheet of adhesive having a backing to the fabric, the sheet of adhesive having a second thickness ranging from about 0.1 mm to about 0.2 mm;
setting the fabric laminated with the sheet of adhesive for a time period of at least one (1) hour;
cutting a score on the backing, the score allowing the backing to be cleanly pulled from the sheet of adhesive;
after setting, contactlessly cutting a shape through the fabric, the sheet of adhesive and the backing simultaneously; and
heat-sealing edges of a cut fabric, sheet of adhesive, and backing.

2. The method of claim 1, wherein the fabric comprises polyester fleece.

3. The method of claim 1, wherein the shape comprises any one of a star, a flower, a heart, a cloud, an oval, a rectangle, a triangle, or an abstract shape.

4. The method of claim 1, wherein contactlessly cutting a shape through the fabric, the sheet of adhesive and the backing simultaneously comprises cutting the shape with a laser through the fabric, the sheet of adhesive and the backing simultaneously.

5. The method of claim 1, wherein the second thickness is about 0.2 mm.

6. A method of manufacturing an adhesive patch, the method comprising:
providing a fleece fabric having a first thickness ranging from about 1.5 mm to about 15 mm;
laminating a sheet of adhesive having a backing to the fleece fabric, the sheet of adhesive having a second thickness ranging from about 3 mm to about 26 mm, the second thickness being greater than the first thickness;
cutting a score on the backing;
after laminating, heat-cutting a shape through the fleece fabric, the sheet of adhesive and the backing.

7. The method of claim 6, wherein heat-cutting a shape through the fleece fabric, the sheet of adhesive and the backing comprises cutting the shape with a laser through the fleece fabric, the sheet of adhesive and the backing simultaneously.

8. The method of claim 6, wherein heat-cutting a shape through the fleece fabric, the sheet of adhesive and the backing comprises:
cutting the shape with a laser through the fleece fabric, the sheet of adhesive, and the backing simultaneously; and
heat-sealing exposed edges of the fleece fabric, the sheet of adhesive, and the backing.

9. The method of claim 6, further comprising curing the sheet of adhesive to the fabric after laminating the sheet of adhesive to the fleece fabric.

10. The method of claim 9, wherein curing the sheet of adhesive to the fleece fabric comprises letting the sheet of adhesive laminated to the fleece fabric set for a time period ranging from one (1) hour to five (5) days.

11. The method of claim 6, wherein laminating a sheet of adhesive having a backing to the fleece fabric comprises bench laminating a back of the fleece fabric to the sheet of adhesive.

12. The method of claim 6, wherein laminating a sheet of adhesive having a backing to the fleece fabric comprises rolling a web of the sheet of adhesive to a web of the fleece fabric.

13. The method of claim 6, wherein laminating a sheet of adhesive having a backing to the fleece fabric comprises:
using warm rollers to melt the sheet of adhesive; and
pressing the melted sheet of adhesive to a back of the fleece fabric.

14. The method of claim 6, wherein the first thickness is 2 mm.

15. The method of claim 6, wherein the first thickness is 10 mm.

16. The method of claim 6, wherein the second thickness is 4 mm.

17. The method of claim 6, wherein the fleece fabric comprises at least one selected from the group of: polyester fleece, microfleece, polar fleece, French terry fleece, cotton fleece, and Sherpa fleece.

18. A method of repairing a fabric article, the method comprising:
placing a patch over a tear of the fabric article, the patch comprising:
a fabric having a first thickness ranging from about 1.5 mm to about 15 mm, the fabric comprising fleece, and
a sheet of adhesive having a backing, the sheet of adhesive having a second thickness ranging from about 3 mm to about 26 mm and laminated to the fabric; and
heat-sealing the patch to the fabric article, thereby (i) adhering the patch to the fabric article, (ii) sealing any exposed edges of the patch, and (iii) repairing the fabric article,
wherein the fabric article comprises fleece, the fleece of the fabric article being the same as the fleece of the fabric of the patch.

19. The method of claim 18, further comprising putting the fabric article through a plurality of washing and drying cycles, wherein the patch can be put through at least 150 washing and drying cycles.

20. The method of claim 18, wherein the patch comprises any one of a star, a flower, a heart, a cloud, an oval, a rectangle, a triangle, or an abstract shape.
